(19) United States
(12) Patent Application Publication
(10) Pub. No.: US 2006/0235839 A1
(43) Pub. Date: Oct. 19, 2006

(54) Using XML as a common parser architecture to separate parser from compiler

(76) Inventors: Muralidhar Krishnaprasad, Fremont, CA (US); Zhen Hua Liu, San Mateo, CA (US); Karuna Muthiah, Redwood City, CA (US)

Correspondence Address: HICKMAN PALERMO TRUONG & BECKER/ORACLE, 2055 GATEWAY PLACE, SUITE 550, SAN JOSE, CA, 95110-1089, US

(21) Appl. No.: 11/204,649

(22) Filed: Aug. 15, 2005

Related U.S. Application Data
(60) Provisional application No. 60/673,232, filed on Apr. 19, 2005.

(51) Int. Cl. G06F 17/30

(52) U.S. Cl. 707/4

(57) ABSTRACT

A method and apparatus for compiling queries is provided. A first query in a first syntax of a query language is received. Based on the first query, a second query in a second syntax of the query language is generated. The first syntax and the second syntax are each among a plurality of syntaxes that are defined for the query language. The second query is parsed to generate parsed information. Based on the parsed information, the second query is compiled by a compiler that does not support compiling of queries in the first syntax.

### PRIORITY CLAIM; CROSS-REFERENCE TO RELATED APPLICATIONS

This application claims priority under 35 U.S.C. §119(e) to U.S. Provisional Patent Application No. 60/673,232, entitled “USING XML AS A COMMON PARSER ARCHITECTURE TO SEPARATE PARSER FROM COMPILER”, filed by Muralidhar Krishnaprasad et al. on Apr. 19, 2005, the entire contents of which are incorporated by reference for all purposes as if fully set forth herein.

This application claims priority under 35 U.S.C. §120 to U.S. patent application Ser. No. 10/948,523, entitled “EFFICIENT EVALUATION OF QUERIES USING TRANSLATION”, filed by Zhen Hua Liu et al. on Sep. 22, 2004, the entire contents of which are incorporated by reference for all purposes as if fully set forth herein.

### FIELD OF THE INVENTION

The present invention generally relates to extensible Markup Language (XML). The invention relates more specifically to a method for using XML for parsing and compiling.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

XML is a markup language that allows tagging of document elements and provides for the definition, transmission, validation, and interpretation of data between applications and between organizations. The XML specification was developed by the W3C consortium and is located on the Internet at “http://www.w3.org/XML”.

The XML Query Language is a query language that is designed for querying a broad spectrum of XML information resources, such as, for example, XML-enabled databases and XML documents. The XML Query Language was derived from a query language called “Quilt”, which in turn was based on features included in other languages, such as XPath, XQL, XML-QL, SQL, and OQL.

Generally, each computer language has its own semantics and syntax. The semantics of a computer language reflects the meanings of the operators, expressions, constructs, keywords, and functionalities supported by that computer language. A syntax defined for a computer language reflects the rules that govern the representation of the computer language semantics. Typically, code or documents written in a particular computer language are parsed and checked for conformance with the syntax of that language before being processed.

The specification for the XML Query Language states that any particular XML-based query language may have multiple syntaxes. For example, one currently defined syntax for the XML Query Language is the XQuery syntax. The XQuery syntax is a human-friendly syntax. A draft specification for the XQuery syntax is described in “XQuery 1.0: An XML Query Language”, W3C Working Draft 4 Apr. 2005, located at “http://www.w3.org/TR/xquery/”, the entire contents of which are incorporated by reference for all purposes as if fully set forth herein. Another currently defined syntax for the XML Query Language is the XQueryX syntax. The XQueryX syntax is a machine friendly syntax and is expressed solely by XML constructs in a way that reflects the structure of the underlying query or document. A draft specification for the XQueryX syntax is described in “XML Syntax for XQuery 1.0 (XQueryX)”, W3C Working Draft 4 Apr. 2005, located at “http://www.w3.org/TR/xqueryx/”, the entire contents of which are incorporated by reference for all purposes as if fully set forth herein.

In order to illustrate the difference between the XQuery and the XQueryX syntaxes, consider an example provided in the XQueryX specification identified above. In this example, an XML document (located at “http://bstore1.example.com/bib.xml”) stores records indicating books that have been published by different publishers. A user wants to obtain a list of books published by Addison-Wesley after 1991, including their year and title. In order to obtain this list, the user may write a query in the XQuery syntax as follows:

```
<bib>
  {
  for $b in doc(“http://bstore1.example.com/bib.xml”)/bib/book
  where $b/publisher = “Addison-Wesley” and $b/@year > 1991
  return
    <book year=“{ $b/@year }”>
      { $b/title }
    </book>
  }
</bib>.
```

The same query written in the XQueryX syntax is as follows:

```
<?xml version=“1.0” encoding=“UTF-8”?>
<?xml-stylesheet type=“text/xsl” href=“xqueryx.xsl”?>
<xqx:module xmlns:xsi=“http://www.w3.org/2001/XMLSchema-instance”
    xmlns:xqx=“http://www.w3.org/2005/04/XQueryX”
    xsi:schemaLocation=“http://www.w3.org/2005/04/XQueryX/
    xqueryx.xsd”>
  <xqx:mainModule>
  <xqx:queryBody>
    <xqx:expr xsi:type=“xqx:elementConstructor”>
    <xqx:tagName>bib</xqx:tagName>
    <xqx:elementContent>
      <xqx:expr xsi:type=“xqx:flworExpr”>
      <xqx:forClause>
        <xqx:forClauseItem>
      <xqx:typedVariableBinding>
      <xqx:varName>b</xqx:varName>
      </xqx:typedVariableBinding>
      <xqx:forExpr>
      <xqx:expr xsi:type=“xqx:pathExpr”>
        <xqx:argExpr>
        <xqx:expr xsi:type=“xqx:functionCallExpr”>
        <xqx:functionName>doc</xqx:functionName>
        <xqx:arguments>
          <xqx:expr xsi:type=“xqx:stringConstantExpr”>
          <xqx:value>http://bstore1.example.com/bib.xml</xqx:value>
          <xqx:expr>
        </xqx:arguments>
        </xqx:expr>
        </xqx:argExpr>
        <xqx:stepExpr>
        <xqx:xpathAxis>child</xqx:xpathAxis>
        <xqx:nameTest>bib</xqx:nameTest>
        </xqx:stepExpr>
        <xqx:stepExpr>
        <xqx:xpathAxis>child</xqx:xpathAxis>
        <xqx:nameTest>book</xqx:nameTest>
        </xqx:stepExpr>
      </xqx:expr>
      </xqx:forExpr>
    </xqx:forClauseItem>
    </xqx:forClause>
    <xqx:whereClause>
    <xqx:expr xsi:type=“xqx:operatorExpr”>
      <xqx:infixOp/>
      <xqx:opType>and</xqx:opType>
      <xqx:arguments>
        <xqx:expr xsi:type=“xqx:operatorExpr”>
        <xqx:infixOp/>
        <xqx:opType>=</xqx:opType>
        <xqx:arguments>
          <xqx:expr xsi:type=“xqx:pathExpr”>
            <xqx:argExpr>
            <xqx:expr xsi:type=“xqx:varRef”>
              <xqx:name>b</xqx:name>
            </xqx:expr>
            </xqx:argExpr>
            <xqx:stepExpr>
            <xqx:xpathAxis>child</xqx:xpathAxis>
            <xqx:nameTest>publisher</xqx:nameTest>
            </xqx:stepExpr>
          </xqx:expr>
          <xqx:expr xsi:type=“xqx:stringConstantExpr”>
              <xqx:value>Addison-Wesley</xqx:value>
            </xqx:expr>
          </xqx:arguments>
          </xqx:expr>
          <xqx:expr xsi:type=“xqx:operatorExpr”>
          <xqx:infixOp/>
          <xqx:opType>&gt;</xqx:opType>
          <xqx:arguments>
            <xqx:expr xsi:type=“xqx:pathExpr”>
              <xqx:argExpr>
              <xqx:expr xsi:type=“xqx:varRef”>
                <xqx:name>b</xqx:name>
              </xqx:expr>
              </xqx:argExpr>
              <xqx:stepExpr>
              <xqx:xpathAxis>attribute</xqx:xpathAxis>
              <xqx:nameTest>year</xqx:nameTest>
              </xqx:stepExpr>
            </xqx:expr>
            <xqx:expr xsi:type=“xqx:integerConstantExpr”>
              <xqx:value>1991</xqx:value>
            </xqx:expr>
          </xqx:arguments>
          </xqx:expr>
        </xqx:arguments>
      </xqx:expr>
      </xqx:whereClause>
      <xqx:returnClause>
      <xqx:expr xsi:type=“xqx:elementConstructor”>
        <xqx:tagName>book</xqx:tagName>
        <xqx:attributeList>
        <xqx:attributeConstructor>
          <xqx:attributeName>year</xqx:attributeName>
          <xqx:attributeValueExpr>
          <xqx:expr xsi:type=“xqx:pathExpr”>
            <xqx:argExpr>
            <xqx:expr xsi:type=“xqx:varRef”>
              <xqx:name>b</xqx:name>
            </xqx:expr>
            </xqx:argExpr>
            <xqx:stepExpr>
            <xqx:xpathAxis>attribute</xqx:xpathAxis>
            <xqx:nameTest>year</xqx:nameTest>
            </xqx:stepExpr>
          </xqx:expr>
          </xqx:attributeValueExpr>
        </xqx:attributeConstructor>
        </xqx:attributeList>
        <xqx:elementContent>
          <xqx:expr xsi:type=“xqx:pathExpr”>
            <xqx:argExpr>
            <xqx:expr xsi:type=“xqx:varRef”>
              <xqx:name>b</xqx:name>
            </xqx:expr>
            </xqx:argExpr>
            <xqx:stepExpr>
            <xqx:xpathAxis>child</xqx:xpathAxis>
            <xqx:nameTest>title</xqx:nameTest>
            </xqx:stepExpr>
          </xqx:expr>
        </xqx:elementContent>
        </xqx:expr>
      </xqx:returnClause>
      </xqx:expr>
    </xqx:elementContent>
    </xqx:expr>
  </xqx:queryBody>
  </xqx:mainModule>
</xqx:module>
```

As it is clear from the above example, the query in the XQuery syntax is much more user-friendly and humanly readable than the same query when written in the XQueryX syntax. On the other hand, the query in the XQueryX syntax is in a format that is suitable for reading and processing by a computing device. In fact, the XQueryX specification itself describes using the XQueryX syntax in order to check whether a query in the XQuery syntax is in proper syntactic conformance.

In general, queries written in query languages are parsed and compiled before being executed. In some implementations, a compiler may perform both the parsing and the compiling of a query by means of a parser module and a compiler module provided in the compiler itself. In other implementations, the parsing of a query may be performed by a parser that is a separate from the compiler. In order to compile a query written in a particular query language, a parser or a parsing module creates an Abstract Syntax Tree (AST) corresponding to the query. The AST is a tree representation of the query, where the different nodes in the tree represent the different elements that make up the query, such as, for example, keywords, variables, operators, operands, constants, etc. The AST is then processed by a compiler, which compiles the query based on the AST and creates a set of executable instructions that facilitate the execution of the query. However, since the elements that make up queries written in a particular query language depend exclusively on the syntax of that language, the parsers and the compilers that process the ASTs corresponding to the queries also depend exclusively on the syntax of the language.

This dependence of the parsers and the compilers on the syntax of the supported query language causes a significant problem when a query-processing engine needs to support a query language that has multiple syntaxes. The developers of the query-processing engine may need to build a separate parser and a separate compiler for each different syntax that is defined for the query language. When a particular syntax of the query language changes (for example, when a new version of that syntax is defined), the developers need to make changes in the parser and the compiler that support the changed syntax. This problem is further exacerbated when the query-processing engine needs to support multiple versions of each syntax that is defined for the query language.

For example, with regards to the XQuery and XQueryX syntaxes of the XML Query Language described above, a XML Query Language engine must have a parser and a compiler for processing queries in the XQuery syntax that are different from the parser and the compiler that process queries in the XQueryX syntax. In practical terms, different sets of parsers/compilers must be built, one set for processing queries in the XQuery syntax and one set for processing queries in the XQueryX syntax.

Based on the foregoing, there is a clear need for techniques that reduce or eliminate the dependency of a compiler on the syntax of the supported query language.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a high level overview of a database system in which an embodiment may be implemented;

FIG. 2 is a flow diagram that illustrates a high level overview of one embodiment of a method for compiling queries; and

FIG. 3 is a block diagram that illustrates a computer system upon which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Structural Overview of One Embodiment

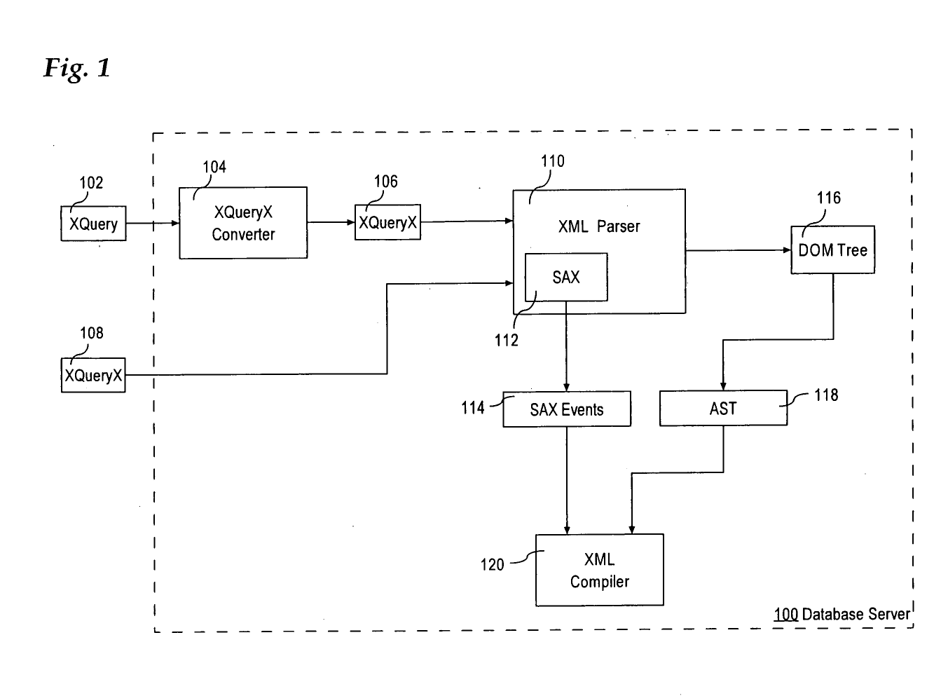

FIG. 1 is a block diagram that illustrates a high level overview of a database server in which one embodiment may be implemented. Database server 100 is configured to manage one or more eXtensible Markup Language (XML) information resources that store data in XML. Database server 100 may store the XML data in one or more tables of a database managed by the database server, or in one or more XML files that are stored outside the database server but which the database server is configured to manage.

In this embodiment, database server 100 comprises XQueryX converter 104, XML parser 110, and XML compiler 120. XQueryX converter 104 comprises logic for receiving and processing queries sent to database server 100. The logic may be implemented in one or more modules that are configured to perform tasks related to receiving queries in the XQuery syntax and converting them to XQueryX syntax. In some embodiments, XQueryX converter 104 may also comprise an XQuery parser that is capable of parsing queries in the XQuery syntax. In other embodiments, XQueryX converter 104 may in addition comprise logic, implemented through one or more modules, that provides for receiving and processing queries that may be written in different now known or later developed syntaxes of the XML Query Language.

XML parser 110 is communicatively coupled to XQueryX converter 104. XML parser 110 is capable of parsing queries and other input that are written in XML. In the embodiment depicted in FIG. 1, XML parser 110 comprises logic, which may be implemented through one or more modules, that provides for receiving queries in the XQueryX syntax and parsing the queries to generate parsed information. XML parser 110 also comprises a Simple API for XML (SAX) 112. SAX 112 is an event-driven Application Programming Interface (API) that provides handlers for reporting parsing events directly to other entities, such as XML compiler 120. The parsing events reported by SAX 112 may be any events that occur during the parsing by XML parser 110 of an XML source. For example, SAX 112 will report as parsing events the start and end of an XML element as they are encountered in the XML source.

The parsed information generated by XML parser 110 from an XML source, such as, for example, a query in the XQueryX syntax or an input from a XML-enabled database, may be a tree structure based on a Document Object Model (DOM) or one or more SAX events generated by a SAX such as SAX 112. The DOM-based tree structures are useful for processing relatively small XML documents, such as queries in the XQueryX syntax. Generating DOM-based tree structures for large XML documents, however, generally puts a great strain on system resources. For example, if the input sent to an XML parser is a large database that must be represented in XML, the XML parser needs to create in memory enormously large DOM tree structures to hold all the data from the database. In these cases, it is much more efficient for the XML parser to use a SAX for generating SAX events, which events represent the XML source being processed by the XML parser by a series of linear events. The entities or XML compilers that receive the SAX events can then build, based on these SAX events, their own trees or other data structures to represent the XML source being parsed.

In the embodiment depicted in FIG. 1, XML compiler 120 is operatively coupled to XML parser 110. XML compiler 120 is a general XML compiler that is capable of compiling and processing parsed information received from XML parser 110. The parsed information may be DOM-based tree structures, or any SAX events that are generated by SAX 112 of XML parser 110.

In operation, XQueryX converter 104 is configured to receive queries that conform to a first syntax defined for the XML Query Language. The first syntax may be the now known XQuery syntax, or any later defined version of the XQuery syntax. Based upon a received query in the XQuery syntax, such as query 102, XQueryX converter 104 generates a query in the XQueryX syntax, such as query 106.

In this embodiment, XQueryX converter 104 may include an XQuery parser that is implemented in the JAVA™ programming language. The XQuery parser is pre-loaded by database server 100, and is configured for parsing queries in XQuery syntax. Upon receiving query 102, XQueryX converter 104 determines that the query is in the XQuery syntax. The query is then passed to the XQuery parser, which parses the query and creates a corresponding internal DOM structure. XQueryX converter 104 then creates an AST based on the internal DOM structure. Based on the AST, XQueryX converter 104 creates query 106 in the XQueryX syntax.

In some embodiments, the XQueryX converter may be configured to receive all queries in the XML Query Language regardless of the syntax. In these embodiments, the XQueryX converter may include logic to determine whether the received query is in the XQueryX syntax. If the query is not in the XQueryX syntax, the query is converted into the XQueryX syntax as described above. If the query is in the XQueryX syntax, the XQueryX converter may further determine the version of the XQueryX syntax, and may convert the query into a preferred XQueryX version if necessary.

In other embodiments, XQueryX converter 104 may be used by database server 100 as a service for converting any XQuery-formatted input into XQueryX syntax. For example, database server 100 may support a Structured Query Language (SQL) operator that accepts as a parameter input in the XQuery syntax. (Such SQL operator may be desirable because, as described above, input in the XQuery syntax is much more user-friendly and is thus more suitable to be used by a human user in a SQL query.) Upon determining that the SQL operator includes input in the XQuery syntax, the process in database server 100 that executes the SQL operator makes a callout to the XQueryX converter 104 to convert the input in the XQueryX syntax.

Query 106, which is in the XQueryX sytnax, is passed from XQueryX converter 104 to XML parser 110. In some embodiments, XML parser 110 may also be configured to receive queries in the XQueryX from entities other than XQueryX converter 104. For example, XML parser 110 may be configured to receive XQueryX queries, such as query 108 depicted in FIG. 1, from external applications or from other processes executed by database server 100.

Since the queries received at XML parser 110 are all in the XQueryX syntax, which is expressed solely in XML constructs, XML parser 110 may be implemented as a general parser for parsing any XML input. For example, when XML parser 110 receives a query in the XQueryX syntax, such as query 106, XML parser 110 creates a DOM tree 116. Based on the DOM tree 116, the XML parser then creates an AST 118 and passes it to XML compiler 120. Alternatively, if XML parser 110 determines that the received XQueryX query is too large or too resource-intensive to process into a DOM tree, XML parser 110 may invoke the handlers in SAX 112 to generate one or more SAX events 114. SAX events 114 are then sent to XML compiler 120.

XML compiler 120 receives parsed information representing the query from XML parser 110. The parsed information may be in the form of ASTs, such as AST 118, or in the form of SAX events, such as SAX events 116. XML compiler 120 then uses the parsed information to build internal compiler trees or other data structures that may be necessary for compiling the query.

In the embodiment depicted in FIG. 1, XML compiler 120 is capable of compiling only input that is represented in XML. Since XML is a widely known and a very stable standard, the techniques for compiling queries described herein provide for isolating the XML compiler from potentially frequent changes that may occur in the constantly evolving syntaxes of the XML Query Language. For example, even if a new version of the XQuery syntax is defined, no changes need to be made to the XML compiler because any newly defined XQuery syntax will be convertible to pure XML representations, such as the XML representations defined by the XQueryX syntax.

The techniques described herein also provide for separating the internal structures used by the parsers that parse received queries from the structures used by the XML compiler to compile the queries. This makes the XML compiler independent from any changes that may have to be made to the parsers. Furthermore, since the XQueryX syntax is based solely on XML constructs, a general XML parser, such as XML parser 110 in FIG. 1, may be used for building parsed information in the form of DOM trees or SAX events. Thus, the techniques described herein provide for isolating the XML compiler that compiles queries in the XML Query Language from the parsers that parse the queries no matter how many syntaxes for the language may be defined.

### Functional Overview

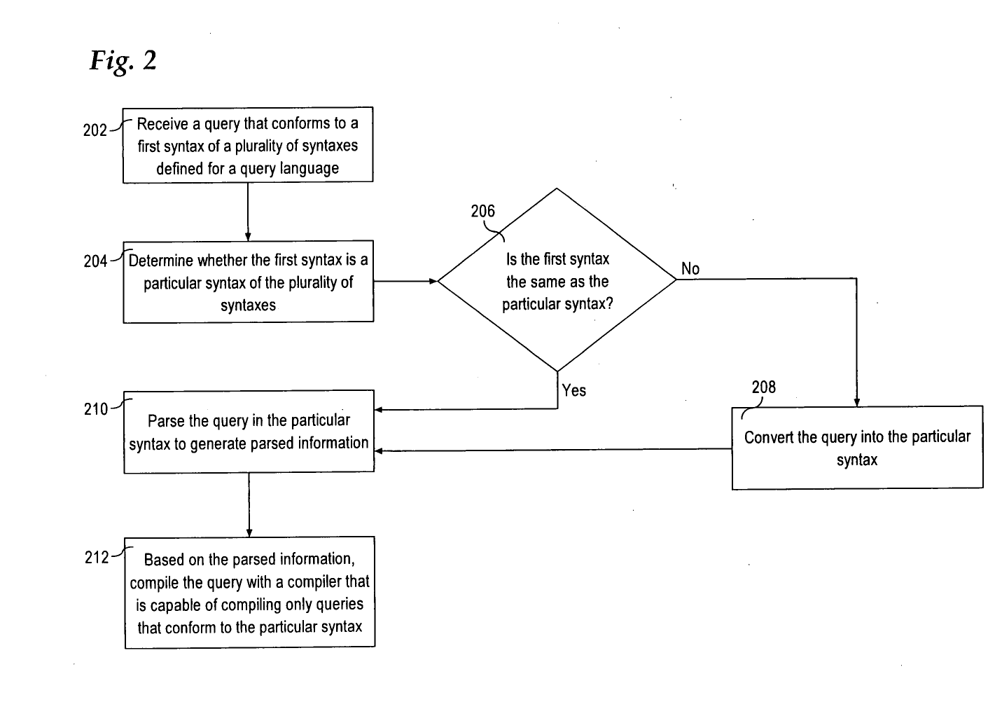

FIG. 2 is a flow diagram that illustrates a high level overview of one embodiment of a method for compiling queries.

In step 202, a query, which conforms to a first syntax of a plurality of syntaxes defined for a query language, is received. In one embodiment, the query language is the XML Query Language, and the first syntax may be any of a XQuery syntax and a XQueryX syntax that are defined for this query language.

In step 204, a determination is made of whether the first syntax is a particular syntax of the plurality of syntaxes. The particular syntax may be any syntax that is chosen to represent a canonical form of received queries. For example, if the query language is the XML Query Language, the particular syntax may be the XQueryX syntax or the XQuery syntax that are defined for that query language. The chosen particular syntax may also be a particular version of a specific syntax. For example, in some embodiments where the query language is the XML Query Language, the particular syntax may be a particular version of the XQueryX syntax.

If in step 206 it is determined that the first syntax is the same as the particular syntax, then in step 210 the query is parsed to generate parsed information. For example, if the query language is the XML Query Language and the particular syntax is the XQueryX syntax, when the received query is in the XQueryX syntax it may be directly parsed to generate an AST or a series of SAX events. If in step 206 it is determined that the first syntax is not the same as the particular syntax, then in step 208 the query is converted into the particular syntax. In step 210, the query in the particular syntax is then parsed to generate parsed information.

Based on the parsed information generated in step 210, in step 212 the query is compiled with a compiler that is capable if compiling only queries that conform to the particular syntax.

The techniques described herein provide for converting a received query into a canonical syntax, where the canonical syntax is a particular syntax of the query language. The parsers, type-checkers, and compilers that subsequently process the query may be built specifically for this canonical syntax. For example, in one embodiment the XQueryX syntax is selected as the canonical syntax. If a received query is in the XQuery syntax, the query is converted into the XQueryX syntax before any further processing. Since the XQueryX syntax is expressed solely in XML, any subsequent parsers and/or compilers need only built XML ASTs to type-check, compile, and eventually execute the query. Further, since in this embodiment all the parsers, type-checkers, and compilers that subsequently process the query need only understand XML, the XML AST structures build for a query may be made available in volatile memory for shared access by the parsers, type-checkers, and compilers.

### Supported Expressions for the XQuery Syntax

In one embodiment, the supported query language is the XML Query Language. The techniques described herein provide for receiving queries in the XQuery syntax, and converting them into the XQueryX syntax. In this embodiment, the queries in the XQuery syntax may include any expressions that are now known or later defined for this syntax. For example, expressions that may be supported include primary expressions, path expressions, sequence expressions, arithmetic expressions, comparison expressions, logical expressions, and FLWOR expressions, as defined in “XQuery 1.0: An XML Query Language”, W3C Working Draft 4 Apr. 2005, located at “http://www.w3.org/TR/xquery/”, the entire contents of which has been incorporated herein by reference.

The primary expressions provided in the XQuery syntax are the primitives of the XML Query Language, and include literals, variable references, context item expressions, constructors, and function calls. A primary expression may also be created by enclosing any expression in parentheses, which also may be used to control the precedence of operators.

The path expressions provided in the XQuery syntax indicate the location of nodes within trees. A path expression consists of a series of one or more steps, separated by “/” or “//”, and optionally beginning with “/” or “//”. Sequence expressions support operators to construct, filter, and combine sequences of items. Arithmetic expressions support various arithmetic operators for addition, subtraction, multiplication, division, and modulus, in binary and unary forms. Comparison expressions in the XQuery syntax allow two values to be compared. The logical expressions in the XQuery syntax include the “and-expression” and the “or-expression”. The logical expressions are evaluated by first determining and then comparing the effective boolean values of the participating operands.

The XQuery syntax also provides FLWOR expressions that support iteration and binding of variables to intermediate results. The term “FLWOR” is based on the “ForClause”, “LetClause”, “WhereClause”, “OrderByClause”, and “ReturnClause” clauses that may comprise a FLWOR expression. The FLWOR expressions are used for computing joins between two or more documents and for restructuring data. For example, the purpose of the “ForClause” and “LetClause” clauses in a FLWOR expression is to produce a tuple stream in which each tuple consists of one or more bound variables. The optional “WhereClause” in a FLWOR expression serves as a filter for the tuples of variable bindings generated by the “ForClause” and/or the “LetClause”. The expression or expressions specified in a “WhereClause”, is evaluated once for each of these tuples. The “ReturnClause” of a FLWOR expression specifies the format of the result of the FLWOR expression, and is evaluated once for each tuple in the tuple stream. An “OrderByClause”, if present, specifies the order in which the elements specified by the “ReturnClause” are ordered in the final result. A full definition and an example of the clauses used in FLWOR expressions is provided in “XQuery 1.0: An XML Query Language”, W3C Working Draft 4 Apr. 2005, located at “http://www.w3.org/TR/xquery/”, the entire contents of which has been incorporated herein by reference.

### Additional Features and Embodiments

In some embodiments, the techniques described herein provide for introducing additional expressions in a received query when the query is converted to the canonical syntax. For example, in one embodiment in which the canonical syntax is the XQueryX syntax, a parser may introduce additional expressions when a query is converted to XQueryX syntax. In this embodiment, additional expressions may also be introduced in the parsed information that is generated by an XML parser that parses a query in the XQueryX syntax.

In this embodiment, before a query in the XQuery or the XQueryX syntax is sent to the XML compiler for compiling, a parser that converts the query from the XQuery syntax to the XQueryX syntax or a parser that parses the XQueryX query may introduce one or more expressions in the query to indicate one or more optimization hints for the compiler. For example, an additional expression may indicate a timeout value, which is used by the XML compiler to indicate a period of time during which the execution of the query must either complete or be terminated. In another example, the additional expression may indicate to the XML compiler that a particular index defined on the XML source must be used when compiling and/or executing the query. In general, the additional expressions added to the original query may be any optimization hints or other parameters that are accepted by the XML compiler.

In some embodiments, the techniques described herein may be used to compile queries that may be written in query languages that have different semantics. For example, Transact-SQL and PL/SQL are SQL query languages that have different semantics. Typically, in compiling a SQL query, the SQL compiler performs both the parsing and the compiling of the query. Since the Transact-SQL and the PL/SQL query languages have different semantics, a given SQL compiler is capable of parsing and compiling queries in only one of the these two SQL query languages but not both. However, the techniques described herein may be used in conjunction with tools that bridge the semantic gap between these two SQL query languages. Since the techniques described herein provide for separating the functionality of parsing from the functionality of compiling, a query in any SQL query language may first be converted in a desired SQL query language (e.g. PL/SQL) by means of parsers or converters that bridge any existing semantic gap. The query may then be compiled by a compiler that is capable of compiling queries in the desired SQL query language (e.g. a PL/SQL compiler).

In various embodiments, the techniques described herein may be implemented in database servers, web servers, e-mail servers, indexing servers, and in any other computer systems or servers that are capable of processing requests for information from a one or more information resources. Further, the information resources may include data any format, which data may be stored in a variety of volatile or persistent storages. For this reason, the examples provided herein of queries, computer languages, and computer systems in which embodiments may be implemented are to be regarded in an illustrative rather than a restrictive sense.

### Hardware Overview

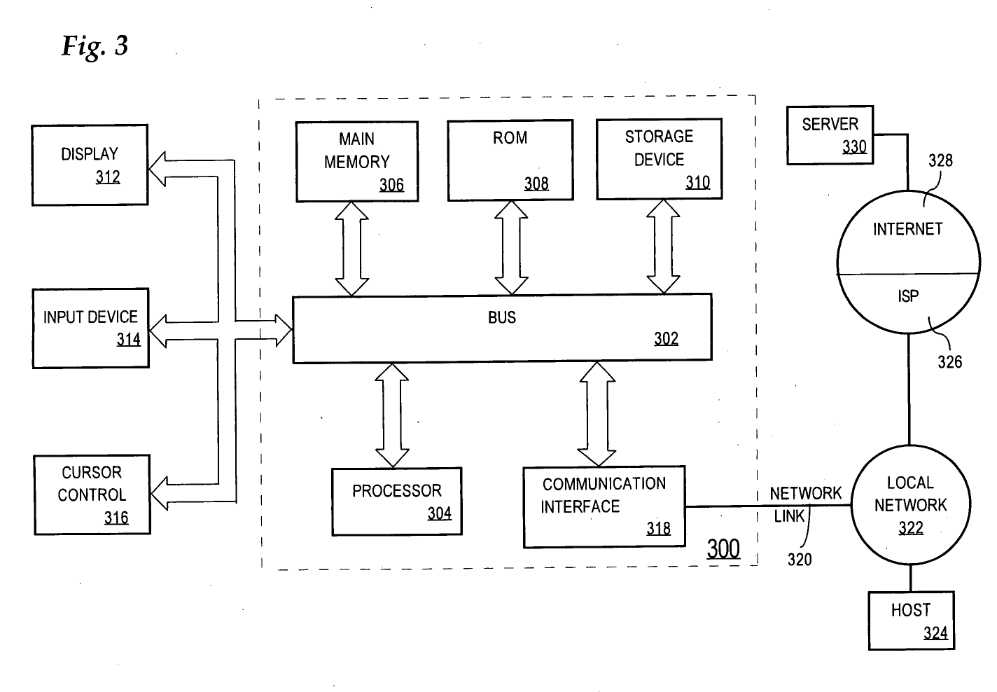

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include,.for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for compiling queries, comprising the computer-implemented steps of:
receiving a first query in a first syntax of a query language;
based on said first query, generating a second query in a second syntax of said query language;.
wherein said first syntax and said second syntax are each among a plurality of syntaxes that are defined for said query language;
parsing said second query to generate parsed information; and
compiling said second query based on said parsed information, wherein said step of compiling is performed by a compiler that does not support compiling of queries in said first syntax.

2. The method of claim 1, wherein:
said compiler is capable of compiling only input that conforms to an eXtensible Markup Language (XML);
said query language is a XML Query Language;
said first syntax is a XQuery syntax defined for said XML Query Language; and
said second syntax is a XQueryX syntax defined for said XML Query Language.

3. The method of claim 1, wherein:
said first query comprises first one or more expressions in said first syntax; and
said second query comprises second one or more expressions in said second syntax, wherein said second one or more expressions correspond to said first one or more expressions.

4. The method of claim 3, wherein said second query further comprises third one or more expressions that do not correspond to any of said first one or more expressions.

5. The method of claim 4, wherein said step of compiling said second query further comprises compiling said second query by taking into account said third one or more expressions.

6. The method of claim 3, wherein each expression of said first one or more expressions is any one of a primary expression, a path expression, a sequence expression, an arithmetic expression, a comparison expression, a logical expression, and a FLWOR expression.

7. The method of claim 3, wherein:
said compiler is capable of compiling only input that conforms to an eXtensible Markup Language (XML);
said query language is a XML Query Language, said first syntax is a XQuery syntax defined for said XML Query Language, and said second syntax is a XQueryX syntax defined for said XML Query Language; and
said first one or more expressions in said first syntax include at least one of:
a ForClause expression;
a LetClause expression;
a WhereClause expression;
an OrderByClause expression; and
a ReturnClause expression.

8. A method for compiling queries, comprising the computer-implemented steps of:
receiving a query that conforms to a first syntax of a plurality of syntaxes defined for a query language;
determining whether said first syntax is a particular syntax of said plurality of syntaxes;
if said first syntax is not said particular syntax, then converting said query into said particular syntax of said plurality of syntaxes defined for said query language;
parsing said query that conforms to said particular syntax to generate parsed information; and
compiling said query based on said parsed information, wherein said step of compiling is performed by a compiler that is capable of compiling only queries that conform to said particular syntax.

9. The method of claim 8, wherein:
said query language is an eXtensible Markup Language (XML) Query Language;
said first syntax is a XQuery syntax defined for said XML Query Language; and
said second syntax is a XQueryX syntax defined for said XML Query Language.

10. The method of claim 8, wherein:
said query comprises first one or more expressions in said first syntax; and
after converting said query into said particular syntax, said query comprises second one or more expressions in said second syntax, wherein said second one or more expressions correspond to said first one or more expressions.

11. The method of claim 10, wherein said first one or more expressions in said first syntax include at least one of:
a ForClause expression;
a LetClause expression;
a WhereClause expression;
an OrderByClause expression; and
a ReturnClause expression.

12. A database server that uses extensible Markup Language (XML) as common parser architecture, comprising:
a XQueryX converter comprising a first logic that:
receives a query that conforms to a first syntax defined for a XML Query Language;
determines whether said first syntax is a XQueryX syntax defined for said XML Query Language; and
if said first syntax is not said XQueryX syntax, then converts said query into said XQueryX syntax;
a XML parser which is capable of parsing queries in said XQueryX syntax, wherein:
said XML parser is communicatively coupled to said XQueryX converter; and
said XML parser comprises a second logic that:
receives said query in said XQueryX syntax, and passes said query to generate parsed information; and
a XML compiler which is capable of compiling input that conforms to XML,
wherein:
said XML compiler is operatively coupled to said XML parser; and
said XML compiler comprises a third logic that compiles said parsed information.

13. A computer-readable medium carrying one or more sequences of instructions which, when executed by one or more processors, causes the one or more processors to perform the method recited in claim 1.

14. A computer-readable medium carrying one or more sequences of instructions which, when executed by one or more processors, causes the one or more processors to perform the method recited in claim 2.

15. A computer-readable medium carrying one or more sequences of instructions which, when executed by one or more processors, causes the one or more processors to perform the method recited in claim 3.

16. A computer-readable medium carrying one or more sequences of instructions which, when executed by one or more processors, causes the one or more processors to perform the method recited in claim 4.

17. A computer-readable medium carrying one or more sequences of instructions which, when executed by one or more processors, causes the one or more processors to perform the method recited in claim 5.

18. A computer-readable medium carrying one or more sequences of instructions which, when executed by one or more processors, causes the one or more processors to perform the method recited in claim 6.

19. A computer-readable medium carrying one or more sequences of instructions which, when executed by one or more processors, causes the one or more processors to perform the method recited in claim 7.

20. A computer-readable medium carrying one or more sequences of instructions which, when executed by one or more processors, causes the one or more processors to perform the method recited in claim 8.

21. A computer-readable medium carrying one or more sequences of instructions which, when executed by one or more processors, causes the one or more processors to perform the method recited in claim 9.

22. A computer-readable medium carrying one or more sequences of instructions which, when executed by one or more processors, causes the one or more processors to perform the method recited in claim 10.

23. A computer-readable medium carrying one or more sequences of instructions which, when executed by one or more processors, causes the one or more processors to perform the method recited in claim 11.
